(19) United States
(12) Patent Application Publication
(10) Pub. No.: US 2007/0268688 A1
(43) Pub. Date: Nov. 22, 2007

(54) USB powered electric torch

(76) Inventor: Chung-Yang Chen, Sindian City (TW)

Correspondence Address: BIRCH STEWART KOLASCH & BIRCH, PO BOX 747, FALLS CHURCH, VA, 22040-0747, US

(21) Appl. No.: 11/437,748

(22) Filed: May 22, 2006

(51) Int. Cl. F21L 4/00

(52) U.S. Cl. 362/183

(57) ABSTRACT

The present invention provides an improved electric torch that is compact and capable of being recharged with a USB port. The electric torch of the present invention is designed with a USB interface to allow the power to be drawn from an external electronic device via a storage device to an illuminator such as a light emitting diode. The electric torch of the present invention further comprises a body, a lighting storage unit and a cover portion. The storage device is electrically connected to one light emitting diode, and power drawn from the USB interface of the body is stored in the storage device and is supplied through the control circuit to the light emitting diode. The electric torch of the present invention is designed with various modes of illuminating functions by pressing the switch button, such as the selective tuning on/off of function, switches the illumination between lighting and flashing.

### BACKGROUND OF THE INVENTION

1. Field of Invention

The present invention relates to an electric torch capable of recharging while using a USB interface.

2. Description of the Related Art

Electricity becomes the most essential in our daily life since it has been discovered centuries ago. With the increasing demands of electrical applications in various areas, the utility and usefulness of electric torches increases, and the torches become more sophisticated and compact.

Most of the conventional electric torches are integrated with batteries, an electrical board, an external cover and a light bulb. A switch is normally designed on the external cover to switch on/off the illumination of the electric torch. Since the utilization of the Light Emitting Diodes (LED) becomes increasingly popular, many torches are utilizing the light emitting diode as the illuminator. Some of the conventional electric torches are equipped with large batteries to provide brighter illumination and longer electrical power. However, those conventional torches are heavy to carry and their large size batteries are expensive to replace.

The conventional batteries used in the torches, such the alkaline batteries, lithium batteries or the mercury batteries, have been developed to increase the capacitance of the battery and its performance. Some techniques have been developed to recycle the usage of the batteries by allowing the batteries to be recharged. However, most of those rechargeable batteries have to be disassembled from the torch in order to be recharged. The recharging devices of the batteries are considered large in size and heavy in weight. Moreover, those rechargeable batteries are not reliable and can easily cause damage to the circuit board of the torch.

Therefore, it is an objective of the present invention to provide a portable and easily powered electric torch without carrying any excess recharging devices.

### SUMMARY OF THE INVENTION

It is an object of the present invention to provide an improved electric torch that is portable and capable of being recharged with USB. The electric torch of the present invention is designed with a USB interface to allow power drawn from an external electronic device via a storage device to an illuminator, such as a light emitting diode.

It is also an object of the present invention to develop a technique to power or recharge the torch with the daily used electrical appliances, such as a computer or a laptop.

It is another object of the present invention to provide a more compact electric torch that is capable of being powered to the USB port of an external electronic device, such as a computer. The electric torch of the present invention comprises a body, a lighting storage unit and a cover portion, wherein the body has a USB interface that can receive power from a USB plug of the external electronic device, and a storage device and a control circuit are located in the light storage unit. The storage device is electrically connected to at least one light emitting diode, and power drawn from the USB interface of the body is stored in the storage device and is supplied through the control circuit to the light emitting diode. The lighting storage unit and an illuminator, such as the light emitting diode, are covered by the cover portion.

Both the forgoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the invention. In the drawings,

FIG. 1 is a 3-D schematic assemble view of an electric torch powered with an USB interface in accordance with a preferred example of the present invention;

FIG. 2 is a 3-D schematic view of the assembled electric torch.

### DESCRIPTION OF THE PREFERRED EMBODIMENTS

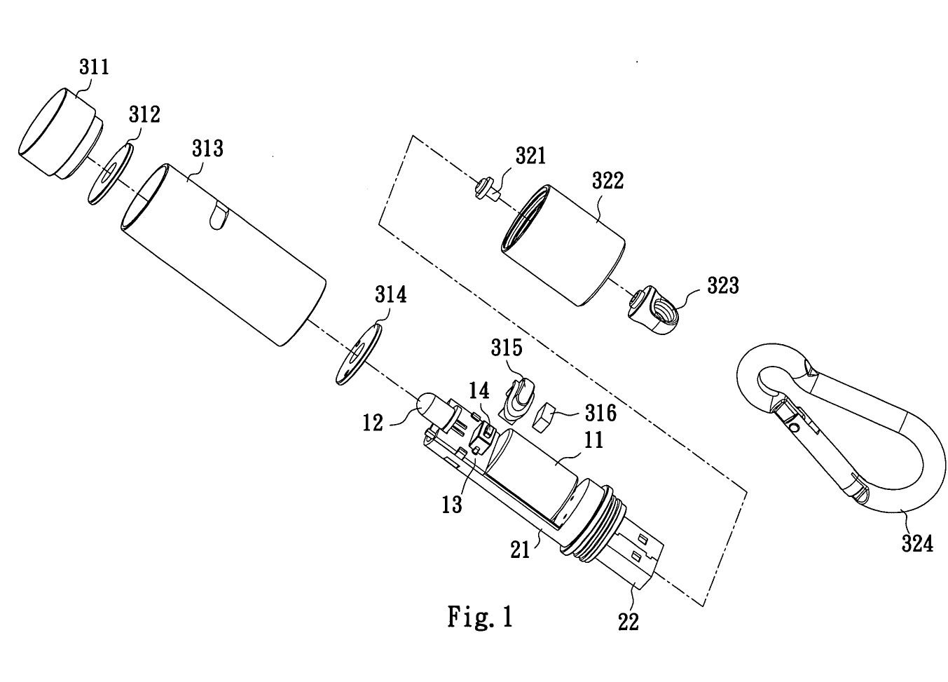

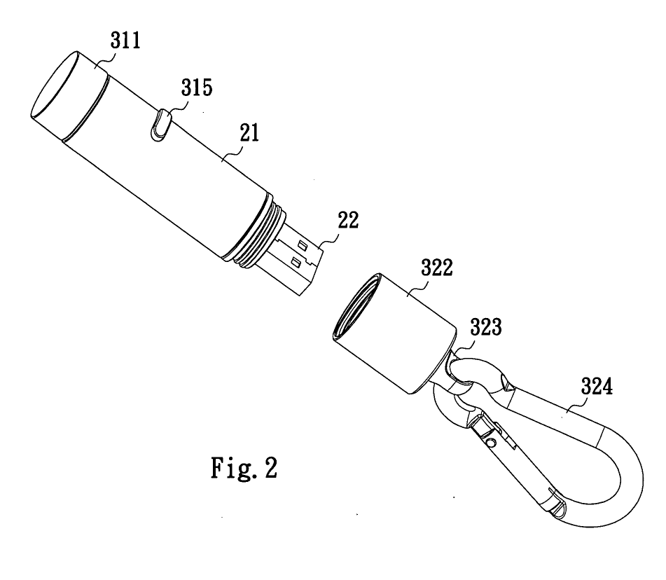

An electric torch powered via the USB of the present invention is illustrated in a preferred example in reference to FIGS. 1 and 2. The electric torch of the present invention comprises a body 21 and one of the standard USB interfaces 22 located at one part of the body. The electric torch further comprises a storage device 11, a control circuit 13, a control switch 14 and at least one light emitting diode (LED) 12 electrically connected together. Although the light emitting diode 12 is useful in the preferred embodiment of the present invention, however, the illumination of the electric torch is not limited to the usage of the light emitting diode, other devices with similar functions, such as light bulb, can also be utilized. The storage device 11 also electrically connected to the USB interface 22 of the body 21 such that the USB interface 22 can transfer the excess electrical power of an external electrical device, such as a computer, to the storage device 11. While one light emitting diode 12 and the control circuit 13 are powered via the storage device 11 during the illumination, the control circuit 14 controls the illuminating mode of the light emitting diode 12.

For the preferred example shown in FIG. 1, an lamp screen 311 and a main cover 313 are integrated together, and a reflector 312 is located in between the lamp screen 311 and the main cover 313. While a seal plate 314 is attached to another end of the main cover 313 together with a switch button 315, a wet cotton 316 is utilized to insulate the contact between the main cover 313 and the seal plate 314 subsequently a short circuit problem can be prevented. The switch button 315 may be located in an opening of the main cover 313, and the illumination modes of the light emitting diode 12 can be switched via the control switch 14. A hooker 324 is engaged to, or formed as part of, a top portion of a connecting body in which a rear cover 322 and a rotating head 323 are engaged through a screw 321. The electric torch of the present invention is designed with the abilities to be portable and recharged easily.

FIG. 2 shows a schematic view of the assembled electric torch with a USB interface 22, the protruding part of the main cover, the switch button 315, allows selective switching between various illumination modes of the light emitting diode. The USB interface 22 is revealed once the rear cover 322 is screwed off from the body 21, and it able to receive power from a USB plug of a peripheral component. Power drawn from the peripheral component and the power supplied to the storage device 11 of the electric torch can be controlled by the control circuit 13 and the control switch 14. The electric torch is designed with various modes of illuminating functions by pressing the switch button 315, such as the selective tuning on/off of function, switches the illumination between lighting and flashing. However, the modes of illumination of the electric torch is not limited to these disclosed embodiments, other modes of illumination can be achieved by modification made to the control circuit and control switch.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. An electric torch, capable of being powered via USB, comprising
a body, having a USB interface, wherein the USB interface can receive power from a USB plug of an external electronic device;
a lighting storage unit, being integrated with the body, wherein the lighting storage unit further comprises a storage device and a control circuit, and the storage device is electrically connected to at least one light emitting diode, power drawn from the USB interface of the body is stored in the storage device and is supplied through the control circuit to the light emitting diode;
a cover portion, covering the lighting storage unit, wherein a lamp screen is provided at an illumination end of the cover portion.

2. The electric torch of claim 1, wherein the storage device and the USB interface are connected with conductive wires.

3. The electric torch of claim 1, wherein a control switch is integrated onto the control circuit that is electrically connected to the light emitting diode so that the light emitting diode can be switched between various illumination modes when the control switch is switched on and off.

4. The electric torch of claim 1, wherein the cover portion further comprises the lamp screen, a reflector, a main cover, a rear cover, a connecting body and a switch button, and those components are assembled subsequently to cover the body of the electric torch in such that the light emitting diode is located at the illumination end of the cover portion while the USB interface is located at another end of the cover portion that is engaged to the rear cover.

5. The electric torch of claim 4, wherein the main cover further comprises an opening configured to match the switch button, and the switch button comes in contact with the control switch located on the control circuit when the switch button is switched on.

6. The electric torch of claim 4, wherein the light emitting diode is surrounded within the reflector and the lamp screen.

7. The electric torch of claim 4, wherein the main cover comprises screw pattern that allows it to be screwed onto the rear cover.

8. The electric torch of claim 4, wherein the connecting body is engaged to the rear cover via a screw.

9. The electric torch of claim 1, wherein the external electronic device is a computer.
